(19) United States
(12) Patent Application Publication
(10) Pub. No.: US 2024/0411556 A1
(43) Pub. Date: Dec. 12, 2024

(54) SYSTEM AND METHOD FOR UNFAIR ADVANTAGE AWARE SPINLOCK

(71) Applicant: Samsung Electronics Co., Ltd., Suwon-si (KR)

(72) Inventors: Anirban SAHA, Bangalore (IN); Surendra SINGH, Bangalore (IN); Tushar VRIND, Bangalore (IN)

(73) Assignee: Samsung Electronics Co., Ltd., Suwon-si (KR)

(21) Appl. No.: 18/678,220

(22) Filed: May 30, 2024

(30) Foreign Application Priority Data
Jun. 7, 2023 (IN) 2023 41039050
May 21, 2024 (IN) 202341039050

(51) Int. Cl. G06F 9/30; G06F 9/38; G06F 9/46

(52) U.S. Cl. CPC G06F 9/30047; G06F 9/38585; G06F 9/468

(57) ABSTRACT

Disclosed herein is a method for providing a fair access to a spinlock to one or more cores in a multicore system. The method includes setting, a spinlock variable by the first core of the one or more cores. The setting of the spinlock variable corresponds to changing a cache state of the spinlock variable in a cache of the first core to MODIFIED. Further, the method includes setting a secondary variable by the second core of the one or more cores. The setting of the secondary variable corresponds to changing a cache state of the secondary variable in a cache of the second core to MODIFIED. Furthermore, the method includes releasing, by the first core, the spinlock after performing one or more operations on the critical section of data. Furthermore, the method includes updating, by the first core, the INVALID secondary variable.

### CROSS-REFERENCE TO RELATED APPLICATIONS

This application claims priority under 35 U.S.C. § 119 to Indian Provisional Application No. 202341039050 filed on Jun. 7, 2023 and to Indian patent application No. 202341039050 filed on May 21, 2024, the entire contents of each of which are incorporated herein by reference.

### BACKGROUND

### Field of the Invention

The present disclosure relates to a field of multicore systems and more specifically relates to a method for providing fair access to a spinlock to one or more cores in a multicore system.

### Description of the Related Art

In multicore systems, a spinlock mechanism is used to prevent multiple threads or processes from accessing a shared resource concurrently on a multicore processor. The spinlock mechanism works by repeatedly checking a spinlock variable in a loop until the lock becomes available, indicating that the shared resource is available. This method of waiting may also be referred to as busy-waiting or spinning, and it avoids the overhead of switching contexts or suspending threads. The thread or process that acquires the lock then sets the spinlock variable, indicating that the shared resource is in use.

FIG. 1 illustrates a flow chart of a method 100 of acquisition of a spinlock in a multicore system, according to an existing state of the art. At operation S101 of the method 100, a core of the multicore system starts the spinlock acquisition to access the shared resources. At operation S103, the core determines whether the spinlock is available or not. The spinlock is determined to be available if the spinlock is not held by any other core. If the spinlock is available, the requesting core acquires the spinlock. At operation S105, the requesting core sets the spinlock variable to one. At operation S107, if the spinlock is not available, the requesting core repeatedly checks the spinlock variable in a loop until the lock becomes available. At operation S109, the requesting core accesses the shared resources and/or critical section of data. At operation S111, the requesting core releases the spinlock after accessing the critical section of data. When the spinlock is released by the core, any other core that is attempting to access the shared resources can acquire the spinlock.

The spinlock mechanism in the multicore systems assumes that every core contending for the spinlock has an equal chance of winning (or acquiring) the spinlock, ensuring fairness. Once a winner core (a core that previously acquired the spinlock) releases the spinlock, all the waiting cores may have the same chance of acquiring the spinlock, including the winner core if the winner core tries to acquire the spinlock again. However, practically, the hierarchical design of memory using caches introduces inherent biases that result in one core consistently winning the spinlock after each release. For example, one of the main reasons for the unfairness in the spinlock mechanism is the delay induced by the amount of cache line invalidations that take place when the spinlock is acquired and released. In busy spin spinlocks, the delay is caused by cache coherence protocol (Delay_CCP). Further, in optimized spinlocks that have power-saving optimizations like Wait for Event (WFE) to avoid busy spin, a further delay is caused by power-saving optimizations (Delay_PSO).

Delay_CCP arises because, when multiple cores contend for the spinlock, the core that acquires the spinlock first holds the spinlock variable in the core's cache line, while other cores' copies of the spinlock variable in their caches become invalid. This cache coherence delay gives the winning core an unfair advantage in subsequent spinlock acquisitions, as other cores must wait for the cache coherence protocol to synchronize.

Delay_PSO, on the other hand, stems from power-saving optimizations implemented in certain architectures. Mechanisms such as the WFE in Advanced RISC Machine (ARM) and backoff techniques introduce delays before other cores attempt to acquire the spinlock. This delay provides an additional advantage to the core that already holds the spinlock, further exacerbating the unfairness.

FIG. 2 illustrates an example scenario depicting unfairness in access to the spinlock in the multicore system, according to an existing state of art.

As shown in the example illustrated in FIG. 2, Core 1 and Core 2 are contending to acquire the same spinlock continuously in a loop and the Core 1 acquires the spinlock first. Then the Core 1 (winner core) sets a cache state of the spinlock variable to MODIFIED in a cache of the Core 1. This invalidates the spinlock variable cache line copies stored in a cache of other waiting cores including the Core 2. The invalidation modifies a cache state of the spinlock variable to INVALID in the cache of the Core 2. The Core 1 performs some critical section activity and then releases the spinlock.

However, after releasing, if the Core 1 and the Core 2 contend to acquire the same spinlock again, the Core 1 has the spinlock variable in its cache line in the Modified (M) state, whereas the Core 2's copy of the spinlock variable in its private cache is in the Invalid (I) state. Therefore, the Core 2 needs to spend some time to reobtain the data (e.g., to read the spinlock variable) from the winner core's cache. Thus, the Core 1 (that first acquired the spinlock) will have an unfair advantage over the Core 2 for all the next acquisitions in the loop due to the delay associated with cache coherence protocol (Delay_CCP). Additionally, this unfair advantage may further increase due to the delay associated with power-saving optimizations (Delay_PSO).

Thus, from the above, it can be gathered that existing spinlock implementations fail to address the unfairness, leading to performance degradation and inefficient resource utilization. Further, fair spinlocks, although capable of mitigating unfairness, are often bulky and introduce significant latency, making the fair spinlocks unpopular in practical applications.

Therefore, there lies a need for an improved spinlock implementation that can address the unfairness caused by the Delay_CCP and the Delay_PSO while maintaining efficiency and minimizing latency.

### SUMMARY

This summary is provided to introduce a selection of concepts, in a simplified format, that are further described in the detailed description of the invention. This summary is neither intended to identify key or essential inventive concepts of the invention nor is it intended for determining the scope of the invention.

In an example embodiment, a method for providing a fair access to a spinlock to one or more cores in a multicore system is disclosed herein. The method includes setting, by a first core of the one or more cores, a spinlock variable in response to the spinlock being acquired by the first core, the setting of the spinlock variable by the first core including changing a cache state of the spinlock variable in a cache of the first core to MODIFIED based on a cache coherency protocol of the multicore system; setting, by a second core of the one or more cores, a secondary variable based on a set of cores, including the second core, waiting for the spinlock, the setting of the secondary variable by the second core including changing a cache state of the secondary variable in a cache of the second core to MODIFIED based on the cache coherency protocol, wherein the cache state of the secondary variable is set on a cache line that is separate from a cache line associated with the spinlock variable, the second core comprises the spinlock variable as INVALID in the cache of the second core, and the first core comprises the secondary variable as INVALID in the cache of the first core; accessing, by the first core and not by the second core, a section of data; releasing, by the first core, the spinlock after performing one or more operations on the section of the data; and updating, by the first core, the INVALID secondary variable upon releasing the spinlock, the updating of the secondary variable including performing the updating such that a number of INVALID variables that are to be updated by each of the first core and the set of cores including the second core becomes equal.

Also disclosed herein is a method for providing a fair access to a spinlock to one or more cores in a multicore system. The method includes setting, by a first core of the one or more cores, a spinlock variable in response to the spinlock being acquired by the first core, the setting of the spinlock variable by the first core including changing a cache state of the spinlock variable in a cache of the first core to MODIFIED based on a cache coherency protocol of the multicore system; setting, by a second core of the one or more cores, a contention indication variable in response to the second core waiting for the spinlock, the second core comprises the spinlock variable as INVALID in a cache of the second core; accessing, by the first core and not by the second core, a section of data; releasing, by the first core, the spinlock after performing one or more operations on the section of the data; and upon releasing the spinlock, cleaning and invalidating, by the first core, spinlock data from the cache of the first core in a case in response to the contention indication variable being set.

Also disclosed herein is a multicore system including a plurality of cores that includes a first core and a second core. The first core is configured to set a spinlock variable in response to the spinlock is acquired by the first core, wherein the setting of the spinlock variable by the first core includes changing a cache state of the spinlock variable in a cache of the first core to MODIFIED based on a cache coherency protocol of the multicore system, wherein the second core is configured to set a secondary variable based on a set of cores including the second core waiting for the spinlock, wherein the setting of the secondary variable by the second core includes changing a cache state of the secondary variable in a cache of the second core to MODIFIED based on the cache coherency protocol, wherein the cache state of the secondary variable is set on a cache line that is separate from a cache line associated with the spinlock variable, wherein the second core comprises the spinlock variable as INVALID in the cache of the second core in response to the set of cores including the second core waiting for the spinlock, wherein the first core comprises the secondary variable as INVALID in the cache of the first core in response to the spinlock being acquired by the first core; and wherein the first core is further configured to access a section of data, release the spinlock after performing one or more operations on the section of data, and update, upon releasing the spinlock, the INVALID secondary variable, the updating of the secondary variable includes performing the update such that a number of INVALID variables that are to be updated by each of the first core and the set of cores including the second core becomes equal.

Also disclosed herein is a multicore system including a plurality of cores that includes a first core and a second core. The first core is configured to set a spinlock variable in the spinlock is acquired by the first core, the setting of the spinlock variable by the first core including changing a cache state of the spinlock variable in a cache of the first core to MODIFIED based on a cache coherency protocol of the multicore system, wherein the second core is configured to set a contention indication variable in response to the second core is waiting for the spinlock, wherein the second core comprises the spinlock variable as INVALID in a cache of the second core; and wherein the first core is further configured to access a section of data, release the spinlock after performing one or more operations on the section of data, and upon releasing the spinlock, clean and invalidate spinlock data from the cache of the first core in a case in response to the contention indication variable being set.

To further clarify the advantages and features of the present invention, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a flow chart of a method of acquisition of a spinlock in a multicore system, according to an existing state of art;

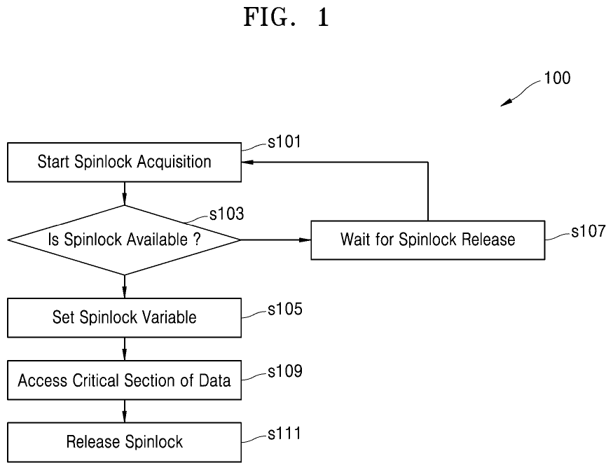

FIG. 2 illustrates an example scenario depicting unfairness in access to the spinlock in the multicore system, according to an existing state of art;

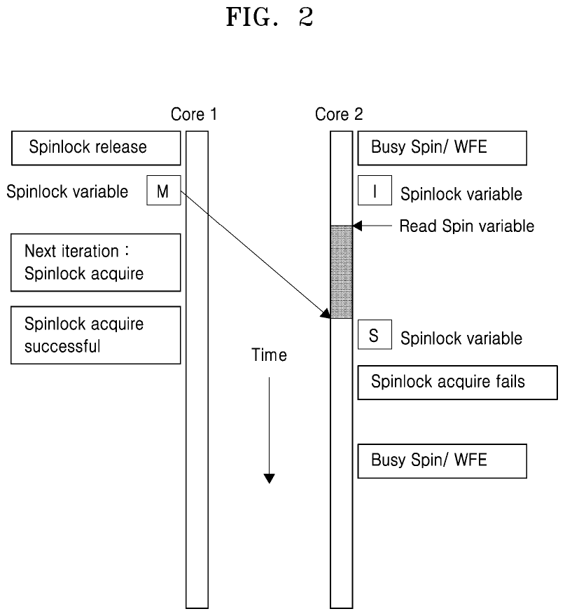

FIG. 3 illustrates a block diagram of a multicore system for providing a fair access to a spinlock to one or more cores in the multicore system, according to one or more embodiments of the present disclosure;

FIG. 4 illustrates a flow chart of a first method for providing the fair access to the spinlock to the one or more cores in the multicore system, according to one or more embodiments of the present disclosure;

FIG. 5 illustrates an example scenario depicting the fair access to the spinlock in the multicore system using the first method, according to one or more embodiments of the present disclosure;

FIG. 6 illustrates a flow chart of a second method for providing the fair access to the spinlock to the one or more cores in the multicore system, according to one or more embodiments of the present disclosure;

FIG. 7 illustrates an example scenario depicting the fair access to the spinlock in the multicore system using the second method, according to one or more embodiments of the present disclosure;

FIG. 8 illustrates a flow chart of a third method for providing the fair access to the spinlock to the one or more cores in the multicore system, according to one or more embodiments of the present disclosure; and

FIG. 9 illustrates a flow chart of a fourth method for providing the fair access to the spinlock to the one or more cores in the multicore system, according to one or more embodiments of the present disclosure.

Further, skilled artisans will appreciate that those elements in the drawings are illustrated for simplicity and may not have necessarily been drawn to scale. For example, the flow charts illustrate the method in terms of the most prominent operations involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having the benefit of the description herein.

### DETAILED DESCRIPTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of operations does not include only those operations but may include other operations not expressly listed or inherent to such process or method. Similarly, one or more devices or sub-systems or elements or structures or components preceded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of modules that carry out a described function or functions. These modules, which may be referred to herein as units, blocks, processing circuitry, and/or the like, (and/or may include processing circuitry, blocks, or units), and are physically implemented by analog or digital circuits such as logic gates, integrated circuits, microprocessors, microcontrollers, memory circuits, passive electronic components, active electronic components, optical components, hardwired circuits, and/or the like; and/or may be driven by firmware and software. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may additionally include circuits including electrical components (such as at least one of transistors, resistors, capacitors, etc., and/or electronic circuits including said components). The circuits may, for example, be embodied in one or more semiconductor chips, or on substrate supports such as printed circuit boards and the like. As such, the circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another. Further, when the terms “about” or “substantially” are used in this specification in connection with a numerical value, it is intended that the associated numerical value includes a manufacturing tolerance (e.g., ±10%) around the stated numerical value. Further, regardless of whether numerical values and/or geometric terms are modified as “about” or “substantially,” it will be understood that these values should be construed as including a manufacturing or operational tolerance (e.g., ±10%) around the stated numerical values.

In one or more embodiments, the present disclosure discloses four example methods by which the unfairness of the spinlock mechanism can be removed. A first method includes adding a secondary variable (WAIT) on a separate cache line from the spinlock variable and setting the WAIT variable (secondary variable) in a loser core. The first method also includes checking and updating the WAIT variable at a winner core on a spinlock release and removing unfairness. A second method includes adding a contention indication by the loser core. The second method further includes cleaning and invalidating, at the winner core, the cache line containing the spinlock based on the contention indication thereby removing the unfairness of the spinlock mechanism. A third method includes adding, when the WAIT variable is set in the loser core, an exact Delay_PSO in updating the WAIT variable at the winner core on the spinlock release and removing unfairness. A fourth method includes adding, in case of contention indication, an exact Delay_PSO in the cleaning and invalidating the cache line containing the spinlock and removing unfairness.

Embodiments will be described below in detail with reference to the accompanying drawings.

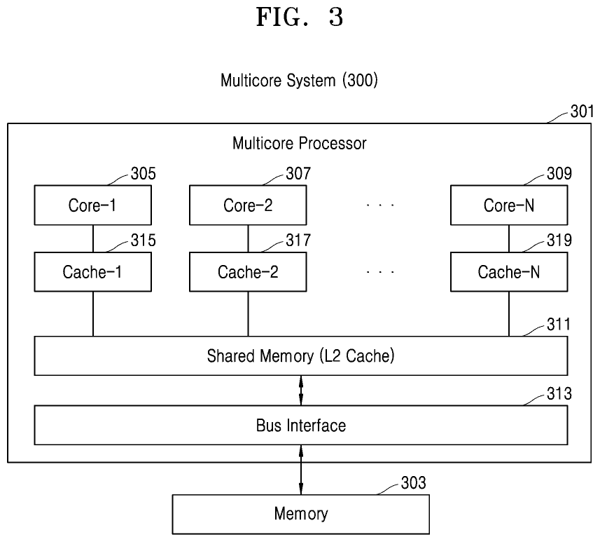

FIG. 3 illustrates a block diagram of a multicore system 300 for providing a fair access to a spinlock to one or more cores in the multicore system 300, according to one or more embodiments of the present disclosure.

The multicore system 300 includes a multicore processor 301 and a memory 303. The multicore processor 301 includes a plurality of cores (Core 1, Core 2, . . . , Core N) (305, 307, . . . , 309) and a plurality of cache memories (Cache 1, Cache 2, . . . , Cache N) (315, 317, . . . , 319) corresponding to each core of the plurality of cores (305, 307, . . . , 309). The multicore processor 301 further includes a shared memory 311 that is shared among the plurality of cores (305, 307, . . . , 309). The multicore processor 301 further includes a bus interface 313 connected to the memory 303.

In at least one embodiment, the multicore processor 301 is a processor chip that has a plurality of processing units on a single chip contained in a single package, wherein the plurality of processing units refer to the plurality of cores (305, 307, . . . , 309) that are configured to perform instructions and/or calculations. Each of the plurality of cores (305, 307, . . . , 309) contains registers and circuitry configured to perform the closely synchronized tasks of ingesting data and instructions, processing the content, and outputting logical decisions and/or results thereof. The plurality of cores (305, 307, . . . , 309) may, for example, perform calculations and run programs at faster speeds than a single processing unit. The plurality of cores (305, 307, . . . , 309) implements multiprocessing in a single physical package. The multicore processor 301 is commonly used in many devices such as computers, smartphones, and tablet devices, to make the devices run faster than they would with a single processing unit.

The plurality of cache memories (315, 317, . . . , 319) corresponds to an L1 cache, which is the smallest and fastest cache unique to every core of the plurality of cores (305, 307, . . . , 309). Each of the plurality of cache memories (315, 317, . . . , 319) is configured to store instructions or data while an operation is performed by the respective core. For example, the plurality of cores (305, 307, . . . , 309) may fetch content from the respective cache memory (if the content is present in the cache) thereby enhancing the performance benefits.

Further, the shared memory 311 corresponds to an L2 cache which is shared among the plurality of cores (305, 307, . . . , 309). The shared memory 311 is slower and larger than the L1 cache. The shared memory 311 stores a copy of a value from the L1 cache.

The bus interface 313 is a communication pathway that connects one or more on-chip components of the multicore system 300 with off-chip components (such as memory 303). The bus interface 313 is a set of circuits that runs throughout the board and connects all the expansion slots, memory, I/O devices, and core.

The memory 303 stores a copy of a value from the L2 cache. The memory 303 includes one or more computer-readable storage media. The computer-readable storage media may be, for example, a non-transitory computer-readable storage media. The memory 303 may include, for example, non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory may, in some examples, be considered a non-transitory storage medium. The term “non-transitory” may indicate that the storage medium is not embodied in a carrier wave or a propagated signal. In other words, the term “non-transitory,” as used herein, is a description of the medium itself (e.g., as tangible, and not a signal) as opposed to a limitation on data storage persistency (e.g., RAM vs. ROM). Therefore, the term “non-transitory” should not be interpreted to mean that the memory is non-movable. In certain examples, a non-transitory storage medium may store data that can, over time, change (e.g., in Random Access Memory (RAM).

Therefore, the memory 303 may further include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, magnetic tapes, etc.

In the multicore system 300, the plurality of cores (305, 307, . . . , 309) is implemented with the plurality of cache memories (315, 317, . . . , 319) and shares the main memory (e.g., 303) and/or the shared memory 311. If more than one core of the plurality of cores (305, 307, . . . , 309) contains a copy of a shared data block of the shared memory 311 and one of the cores modifies the copy of the shared data block it would result in the data inconsistency. For instance, one of the cores will have a modified copy of the shared data block, and other cores will have an old copy of the shared data block. This problem may be called a cache coherency problem. To overcome the cache coherency problem, the plurality of cores (305, 307, . . . , 309) implements a cache-coherence protocol to ensure a coherent view of memory that can be cached and accessed by the plurality of cores (305, 307, . . . , 309).

The cache-coherence protocol is classified based on the cache states of each cache block. For instance, the cache-coherence protocol may be a 3-state MSI protocol, 4-state MOSI protocol, 4-state MESI protocol, 5-state MOESI protocol, or other cache-coherence protocol. The various states of the cache-coherence protocol are a Modified (M) state, Exclusive (E) state, Shared(S) state, Invalid (I) state, or Owned (O) state.

In the Modified (M) state, the shared data block in the cache is MODIFIED and the core that modified the shared data block is the owner of the shared data block. This copy of the shared data block is not available with any other caches in the system. The shared memory 311 copy for the same shared data block does not contain the modified value of the shared data block. Thus, the core with shared data block with MODIFIED state has to write the shared data block back to the shared memory 311 when the shared data block is released by the core (e.g., in response to the shared data block being released).

In the Exclusive (E) state, the shared memory block is only present in the shared memory 311 and in the core which wants to modify the shared memory block. The copy of the same data block is INVALID in the other cores. As such, here the core which wants to modify the shared memory block is the exclusive owner of the shared data block.

In the Shared(S) state, the shared data block in the shared memory 311 is shared by multiple cores and all cores have a valid copy of the shared data block in their cache.

In the Invalid (I) state, the cache has a shared data block that is INVALID. As such, the cache has to send a request to the owner of the same shared data block or the shared memory 311 if the cache wants to read or write/modify this shared data block.

In the Owned (O) state, the shared data block in the shared memory 311 is shared by multiple cores and all cores have a valid copy of the shared data block in their cache. However, the copy in the main memory can be incorrect. For example, in at least one embodiment, only one core holds the shared data block in the owned state while all other cores hold the data in the shared state.

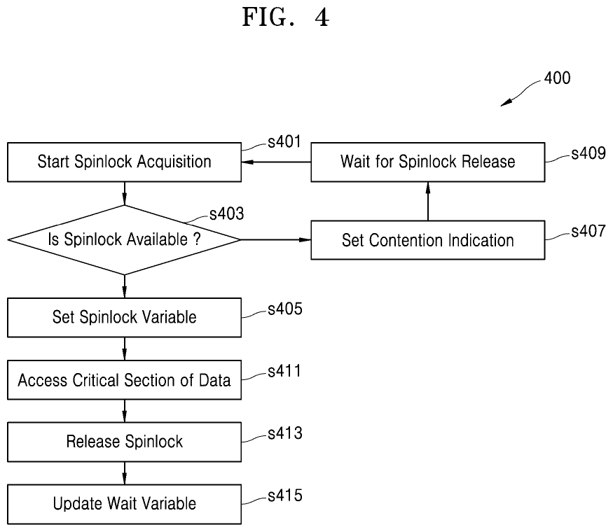

FIG. 4 illustrates a flow chart of a first method 400 for providing the fair access to the spinlock to the one or more cores in the multicore system 300, according to one or more embodiments of the present disclosure. The first method 400 includes a series of operations S401 through S415 performed by the one or more cores of the plurality of cores (305, 307, . . . , 309) of the multicore system 300.

At operation S401, the one or more cores of the plurality of cores (305, 307, . . . , 309) start a contention to acquire the spinlock to access a critical section of data. Each of the one or more cores is assumed to have an equal chance of winning or acquiring the spinlock in the contention. The flow of the first method 400 now proceeds to operation S403.

At operation S403, each of the one or more cores determines whether the spinlock is available. The spinlock is determined to be available if the spinlock is not held by any other core. One core (of the one or more cores) which first determines that the spinlock is available acquires (or wins) the spinlock and the flow of the first method 400 proceeds to operation S405. Further, for the other cores of the one or more cores, for whom it is determined that the spinlock is not available, the flow of the first method 400 proceeds to operation S407.

At operation S405, a winner core (which acquires the spinlock) sets the spinlock variable. For example, the setting of the spinlock variable by the winner core corresponds to changing a cache state of the spinlock variable in a cache of the winner core to MODIFIED based on the cache coherency protocol. The cache state of the spinlock variable, when changed to the MODIFIED, indicates that the cache line associated with the spinlock variable is only present in the cache of the winner core. The flow of the first method 400 now proceeds to operation S411 for the winner core.

At operation S407, a loser core (or cores) (which fails to acquire the spinlock) sets a secondary variable (WAIT variable). For example, the setting of the secondary variable by the loser core corresponds to changing a cache state of the secondary variable in a cache of the loser core to MODIFIED based on the cache coherency protocol. The cache state of the secondary variable, when changed to MODIFIED, indicates that the cache line associated with the secondary variable is only present in the cache of the loser core. The flow of the first method 400 now proceeds to operation S409 for the loser core(s).

In one or more embodiments, the cache state of the secondary variable is set on a cache line that is separate from a cache line associated with the spinlock variable. Further, setting the spinlock variable in the cache of the winner core invalidates the spinlock variable cache line copies which are stored in the caches of other CPU cores including the loser core. Therefore, the spinlock variable is set as INVALID in the cache of the loser core. The spinlock variable that is INVALID in the cache of the loser core indicates that the cache line associated with the spinlock variable that is present in the cache of the loser core is invalid. Similarly, the winner core comprises the secondary variable as INVALID in the cache of the winner core. The secondary variable that is INVALID in the cache of the winner core indicates that the cache line associated with the secondary variable that is present in the cache of the winner core is invalid.

At operation S409, the loser core repeatedly checks the spinlock variable in a loop until the spinlock becomes available. This method of waiting is called busy-waiting or spinning, and it avoids the overhead of switching contexts or suspending threads. After the spinlock becomes available, the loser core again contends to acquire the spinlock after reobtaining the spinlock variable from the CPU core's cache (updates the INVALID spinlock variable).

At operation S411, the winner core accesses the shared resources and/or critical section of data. The flow of the first method 400 now proceeds to operation S413 the the winner core.

At operation S413, the winner core releases the spinlock after performing one or more operations on the critical section of data. When the spinlock is released by the winner core, any other CPU cores (including the loser core) which is attempting to access the shared resources can acquire the spinlock. To acquire the spinlock, the loser core first updates the INVALID spinlock variable upon the release of the spinlock by the winner core. The flow of the first method 400 now proceeds to operation S415 for the winner core.

At operation S415, the winner core updates, upon releasing the spinlock, the INVALID secondary variable (WAIT variable) in the cache of the winner core. The updating of the secondary variable is performed so that a number of INVALID variables that are to be updated by each of the winner core and the other CPU cores, including the loser core, becomes equal.

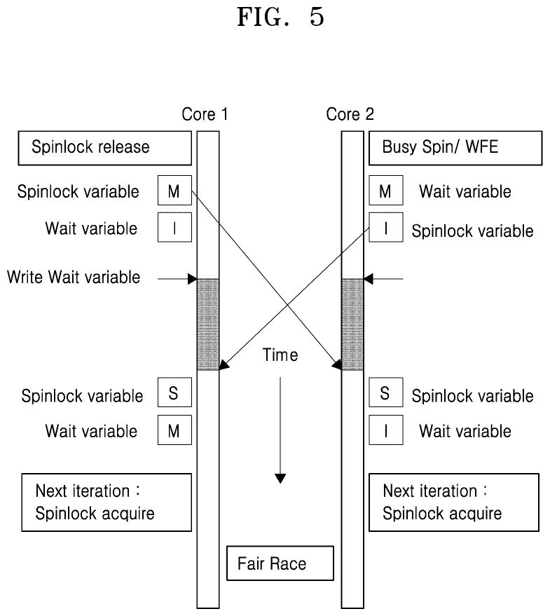

FIG. 5 illustrates an example scenario depicting the fair access to the spinlock in the multicore system 300 using the first method 400, according to one or more embodiments of the present disclosure.

As shown in FIG. 5, consider the Core 1 (e.g., 305) and the Core 2 (e.g., 307) are contending to acquire the same spinlock continuously in a loop and the Core 1 (305) acquires the spinlock first, then the Core 1 (305) set a cache state of the spinlock variable to MODIFIED in a cache of the Core 1 (305). This invalidates the spinlock variable cache line copies stored in a cache of other waiting cores including the Core 2 (307). The invalidation modifies a cache state of the spinlock variable to INVALID in the cache of the Core 2 (307).

Further, the Core 2 (307), which fails to acquire the spinlock, sets the cache state of the secondary variable (WAIT variable) in the cache of the Core 2 (307) to MODIFIED. This sets the secondary variable (WAIT variable) as INVALID in the cache of the Core 1 (305).

Thereafter, the Core 2 (307) repeatedly checks the spinlock variable in the loop until the spinlock becomes available. Further, when the Core 1 releases the spinlock, the spinlock becomes available for contention.

At this point, to acquire the spinlock, the Core 1 (305) updates the INVALID secondary variable (WAIT variable) in the cache of the Core 1 (305) and the Core 2 (307) updates the INVALID spinlock variable in the cache of the Core 2 (307). Therefore, in the case of Delay_CCP, the number of INVALID variables that are to be updated by each of the Core 1 (305) and the Core 2 (307) before acquiring the spinlock becomes equal. Thus, the method of adding the WAIT variable on the separate cache line from the spinlock variable provides a fair access to the spinlock in the multicore system 300.

In one or more embodiments, considering there are “n” threads corresponding to “n” cores trying to acquire a spinlock “S”. As per the software implementation, the expected probability of each thread in each core Pᵢ to acquire spinlock may be given by equation 1:

$${P}_{i} = \frac{1}{n} \qquad ( 1 )$$

With reference to an idealized equation 1, each thread acquires the same probability. The method expects every core, contending for the same spinlock, to have an equal probability of winning the spinlock automatically. Once the winner core releases the spinlock, all the waiting cores have an equal chance of winning the spinlock, including the winner core.

In reality, due to the inherent hierarchical design of memory using caches, the winning core keeps winning the spinlock post every release. For example, due to the fact that at t₁, the winner core may try to acquire the spinlock again whereas other threads in other cores may attempt to acquire the spinlock at t₁+Δ, due to the delays in inter-core communications. At time t₁, the probability of the winner core acquiring the spinlock again may be greater than the other cores and may inversely depend on the time the core takes to access and update the spinlock variable present in the L1 cache of the winner core. The time taken by the winner core to access the lock variable is shown below in Equation 2:

$${T}_{w i n n e r} = {T}_{l 1} \qquad ( 2 )$$

For the loser core, the spinlock variable may not be present in the cache. The probability of the loser core acquiring the spinlock is inversely proportional to the access latency. The time taken by the loser core to access the lock variable may be given by the below equation 3:

$${T}_{loser} = {T}_{l 1} + {T}_{scu for SPIN var} \qquad ( 3 )$$

Where the T_{scu} is the time applied by a Snoop Control Unit (SNU) to ensure the coherency of spinlock variable data from between the L1 cache of the winner core and the loser core. The SCU connects multiple cores to the memory system and maintains coherency between the L1 data cache of each core.

As such, from equations 2 and 3, the number of cores (n) contending for the spinlock is different at different time instances. At any point of time, only one winner core is contending as the loser core has the disadvantage of the Tscu. This can be represented as shown below in Equation 4:

$$n ∈ \{ 1 at ( {t}_{1} ) , n at ( {t}_{1} + Δ ) \} \qquad ( 4 )$$

As a result of equation 4, the probability in equation 1 becomes as follows as shown below in equation 5:

$${P}_{i} ∈ \{ \frac{1}{1} at ( {t}_{1} ) if i = winner core , \qquad ( 5 )$$

$$0 at ( {t}_{1} ) if i = loser core ,$$

$$\frac{1}{n} at ( {t}_{1} + Δ ) for any core \}$$

In particular, the spinlock gets acquired before Δ elapses. Therefore, the probability never reaches 1/n. Hence, only one core (previous winner core) wins every time.

In accordance with the first method 400, which adds the WAIT variable, the winner core is required to access the WAIT variable present in the loser core's cache. This access has a latency of Δ, and that makes the probability (1/n) always as expected by the spinlock mechanism. Equation 2 then becomes:

$${T}_{w i n n e r} = {T}_{l 1} + {T}_{scu for WAIT var} \qquad ( {2}^{′} )$$

Here, T_{scu} from both winner and loser cores cancel each other out and the number of cores contending always becomes n, thereby making the probability to 1/n.

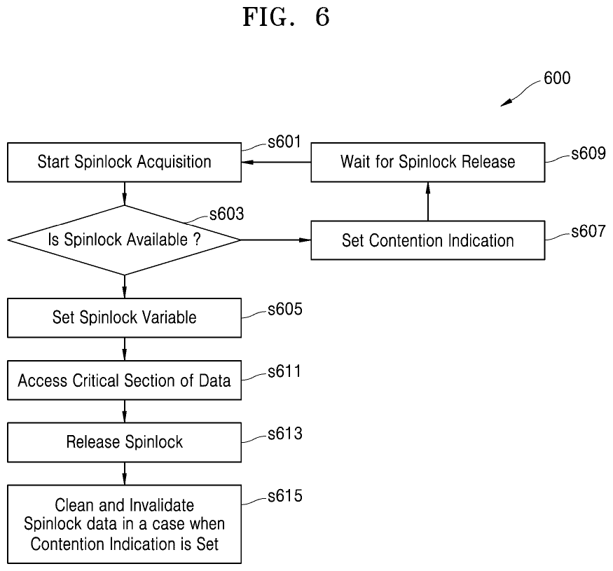

FIG. 6 illustrates a flow chart of a second method 600 for providing the fair access to the spinlock to the one or more cores in the multicore system, according to one or more embodiments of the present disclosure. The second method 600 includes a series of operations S601 through S615 performed by the one or more cores of the plurality of cores (305, 307, . . . , 309) of the multicore system 300.

At operation S601, the one or more cores of the plurality of cores (305, 307, . . . , 309) start the contention to acquire the spinlock to access the critical section of the data. Each of the one or more cores is assumed to have an equal chance of winning or acquiring the spinlock in the contention. The flow of the second method 600 now proceeds to operation S603.

At operation S603, each of the one or more cores determines whether the spinlock is available. The spinlock is determined to be available if the spinlock is not held by any other core. One core of the one or more cores which first determines that the spinlock is available, acquires (or wins) the spinlock, and the flow of the second method 600 proceeds to operation S605 for the winner core. Further, for the other cores (of the one or more cores) for whom the spinlock is not available, the flow of the second method 600 proceeds to operation S607.

At operation S605, the winner core (which acquires the spinlock) sets the spinlock variable. The setting of the spinlock variable by the winner core corresponds to changing the cache state of the spinlock variable in the cache of the winner core to MODIFIED based on the cache coherency protocol. The flow of the second method 600 now proceeds to operation S611 for the winner core.

At operation S607, a loser core (and/or cores) (which fails to acquire the spinlock) sets a contention indication variable indicating that the loser core is waiting for the spinlock. The contention indication variable indicates that a contention is present for acquiring the spinlock. The flow of the second method 600 now proceeds to operation S609 for the loser core(s).

In one or more embodiments, the contention indication variable is set on the same cache line as the spinlock variable, or the contention indication variable is not stored in a cache memory. Further, setting the spinlock variable in the cache of the winner core invalidates the spinlock variable cache line copies which are stored in the caches of other CPU cores including the loser core. Therefore, the loser core comprises the spinlock variable as INVALID in the cache of the loser core.

At operation S609, the loser core repeatedly checks the spinlock variable in a loop until the spinlock becomes available. This method of waiting is called busy-waiting or spinning, and it avoids the overhead of switching contexts or suspending threads. After the spinlock becomes available, the loser core again contends to acquire the spinlock.

At operation S611, the winner core accesses the shared resources or critical section of data. The flow of the second method 600 now proceeds to operation S613 for the winner core.

At operation S613, the winner core releases the spinlock after performing one or more operations on the critical section of data. When the spinlock is released by the winner, any other CPU cores including the loser core which is required to access the shared resources can acquire the spinlock. The flow of the second method 600 now proceeds to operation S615 for the winner core.

At operation S615, the winner core cleans and invalidates, upon releasing the spinlock, spinlock data from the cache of the winner core based on the contention indication variable being set. The cleaning and invalidating of the spinlock data indicates flushing the spinlock data from the cache of the winner core and writing the spinlock variable to a main memory.

The cleaning and invalidating of the spinlock data is performed so that there would be a cache miss for all cores for the spinlock data. Therefore, each core needs to fetch the spinlock data from the main memory and all cores have a fair chance of acquiring the spinlock.

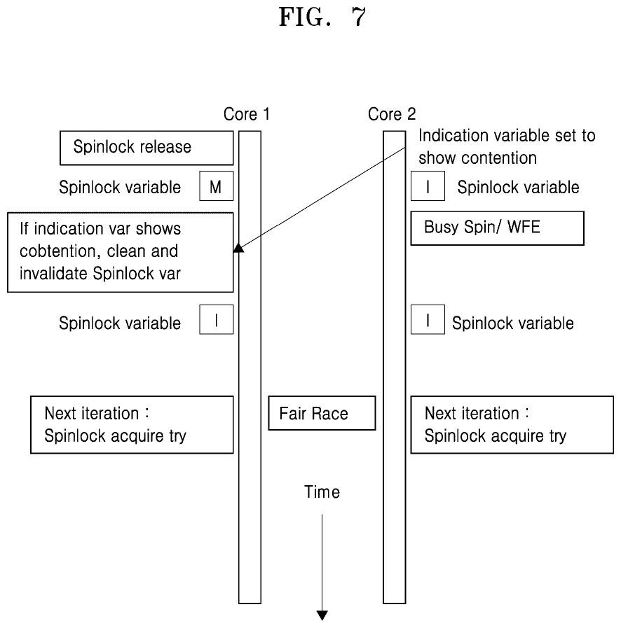

FIG. 7 illustrates an example scenario depicting the fair access to the spinlock in the multicore system using the second method 600, according to one or more embodiments of the present disclosure.

As shown in FIG. 7, consider the Core 1 (e.g., 305) and the Core 2 (e.g., 307) are contending to acquire the same spinlock continuously in a loop and the Core 1 (305) acquires the spinlock first, then the Core 1 (305) set a cache state of the spinlock variable to MODIFIED in a cache of the Core 1 (305). This invalidates the spinlock variable cache line copies stored in a cache of other waiting cores including the Core 2 (307). The invalidation modifies a cache state of the spinlock variable to INVALID in the cache of the Core 2 (307).

Further, the Core 2 (307), which fails to acquire the spinlock, sets the contention indication variable indicating that the Core 2 (307) is waiting for the spinlock. The contention indication variable is set on the same cache line as the spinlock variable, or the contention indication variable is not stored in the cache memory.

Thereafter, the Core 2 (307) repeatedly checks the spinlock variable in the loop until the spinlock becomes available. Further, when the Core 1 releases the spinlock, the spinlock becomes available for contention.

At this point, the Core 1 (305) cleans and invalidates the spinlock data from the cache of the Core 1 (305) in a case when the contention indication variable is set. The cleaning and invalidating of the spinlock data indicates flushing the spinlock data from the cache of the Core 1 (305) and writing the spinlock variable to the main memory. Therefore, in case of Delay_CCP, each core needs to fetch the spinlock data from the main memory and all cores have a fair chance of acquiring the spinlock. Thus, the method of adding the contention indication variable provides a fair access to the spinlock in the multicore system 300.

In accordance with the second method 600, which adds the contention indication, there would be a cache miss for all cores for the spinlock data. The spinlock data, which is not available in any L1 cache would have to be fetched from the main memory. Therefore, the time taken by each core to access the lock variable is shown below in Equation 6:

$${T}_{W i n ner / loser} = {T}_{l1} + {T}_{s c u} + {T}_{R A M} \qquad ( 6 )$$

This makes sure that all cores have a fair chance of acquiring a lock and the probability becomes (1/n).

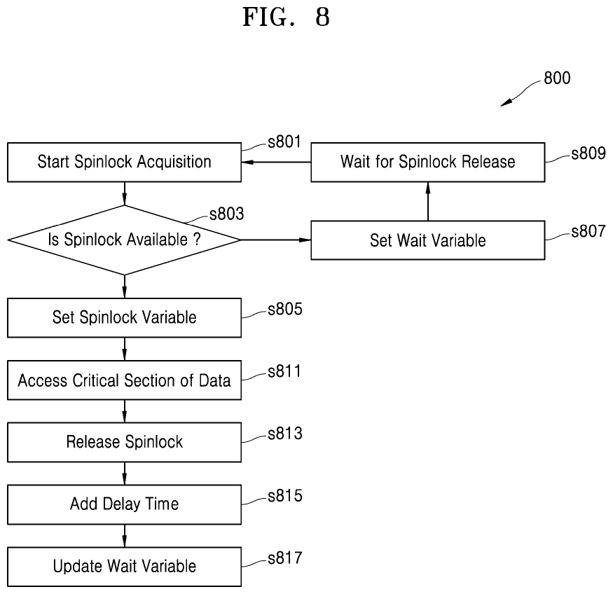

FIG. 8 illustrates a flow chart of a third method 800 for providing the fair access to the spinlock to the one or more cores in the multicore system 300, according to one or more embodiments of the present disclosure. The third method 800 includes a series of operations 801 through 817 performed by the one or more cores of the plurality of cores (305, 307, . . . , 309) of the multicore system 300.

The third method 800 provides a solution for the fair access to the spinlock to one or more cores when the loser core has the Delay_PSO along with Delay_CCP and the WAIT variable is added to the loser core. When the power saving optimizations, such as waking up from sleep (WFE-SEV) and backoff, are used in the loser core, a further delay is caused in the loser core due to power saving optimizations (Delay_PSO). Therefore, the loser core has the Delay_PSO along with Delay_CCP in a case when the WAIT variable is added to the loser core.

The method operations S801 through S813 of the third method 800 are substantially similar to the corresponding method operations S401 through S413 of the first method 400, therefore a detailed explanation is omitted herein for the sake of brevity of the disclosure.

At operation S815, the winner core adds, upon releasing the spinlock, a delay time in resetting the secondary variable (WAIT variable). The delay time corresponds to delay due to power saving optimization (Delay_PSO) in the loser core in the multicore system 300. The delay time is added such that all cores have similar delays. The flow of the third method 800 now proceeds to operation S817 for the winner core.

At operation S817, the winner core updates, upon addition of the delay time, the INVALID secondary variable (WAIT variable) in the cache of the winner core. The updating of the secondary variable is performed so that a number of INVALID variables that are to be updated by each of the winner core and the other CPU cores including the loser core becomes equal.

For the loser core, the spinlock variable may not be present in the cache. The time taken by the loser core to access the lock variable may be given by the below equation 7:

$${T}_{l o s e r} = {T}_{l 1} + {T}_{scu for SPIN var} + {T}_{D e l a {y}_{-} P S O} \qquad ( 7 )$$

In accordance with the third method 800, which adds the WAIT variable, there would be the Delay_PSO along with Delay_CCP. The time taken by the winner core to access the lock variable is shown below in Equation 8:

$${T}_{W i nner} = {T}_{l 1} + {T}_{scu for WAIT var} + {T}_{D e l a {y}_{-} P S {O}_{-} compensation} \qquad ( 8 )$$

The duration of the Delay_PSO compensation may be similar to that of the Delay_PSO in that architecture or implementation of a spinlock is being used. This makes sure that all cores have a fair chance of acquiring a lock and the probability becomes (1/n).

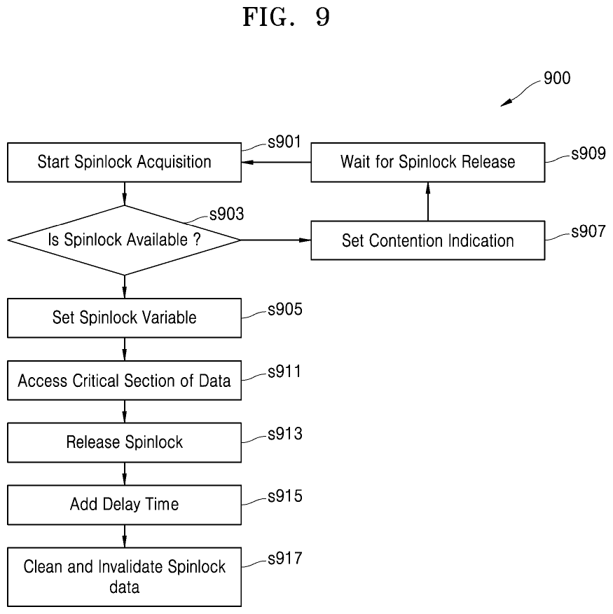

FIG. 9 illustrates a flow chart of a fourth method 900 for providing the fair access to the spinlock to the one or more cores in the multicore system, according to one or more embodiments of the present disclosure. The fourth method 900 includes a series of operations 901 through 917 performed by the one or more cores of the plurality of cores (305, 307, . . . , 309) of the multicore system 300.

The fourth method 900 provides a solution for the fair access to the spinlock to one or more cores when the loser core has the Delay_PSO along with Delay_CCP and the contention indication variable is added to the loser core. For example, in response to the power saving optimizations (such as waking up from sleep (WFE-SEV) and/or backoff) are used in the loser core, a further delay may be caused in the loser core due to power saving optimizations (Delay_PSO). Therefore, the loser core has the Delay_PSO along with Delay_CCP in a case when the contention indication variable is added to the loser core.

The method operations from S901 through S913 of the fourth method 900 are substantially similar to the method operations S601 through S613 of the second method 600, therefore a detailed explanation is omitted herein for the sake of brevity of the disclosure.

At operation S915, the winner core adds, upon releasing the spinlock, the delay time in the cleaning and invalidating of the spinlock data. The delay time corresponds to delay due to power saving optimization (Delay_PSO) in the loser core in the multicore system 300. The delay time is added such that all cores have similar delays. The flow of the fourth method 900 now proceeds to operation S917 for the winner core.

At operation S917, the winner core cleans and invalidates, upon addition of the delay time, the spinlock data in the cache of the winner core in the case when the contention indication variable is set. The cleaning and invalidating of the spinlock data is performed so that there would be a cache miss for all cores for the spinlock data. Therefore, each core needs to fetch the spinlock data from the main memory and all cores have a fair chance of acquiring the spinlock.

In accordance with the fourth method 900, the time taken by each core to access the lock variable is shown below in Equation 9:

$${T}_{W i n ner / loser} = {T}_{l 1} + {T}_{s c u} + {T}_{R A M} + {T}_{D e l a {y}_{-} P S {O}_{-} compensation} \qquad ( 9 )$$

This makes sure that all cores have a fair chance of acquiring a lock and the probability becomes (1/n).

The one or more methods disclosed herein in one or more embodiments provide various technical benefits and advantages during spinlock acquisition. The one or more methods disclosed here provide a solution to avoid starvation and eventual crashes which occur when one of the cores keeps on acquiring the same spinlock in a big loop continuously. The one or more methods disclosed here further improve latency in the other core when one of the cores is acquiring the same spinlock in a big loop.

The various actions, acts, blocks, operations, or the like in the flow diagrams may be performed in the order presented, in a different order, or simultaneously. Further, in some embodiments, some of the actions, acts, blocks, operations, or the like may be omitted, added, modified, skipped, or the like without departing from the scope of the invention.

Unless otherwise defined, all technical and scientific terms used herein have the same meaning as commonly understood by one ordinary skilled in the art to which this invention belongs. The system, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

What is claimed is:

1. A method for providing, to one or more cores in a multicore system, fair access to a spinlock, the method comprising:
setting, by a first core of the one or more cores, a spinlock variable in response to the spinlock being acquired by the first core, the setting of the spinlock variable by the first core including changing a cache state of the spinlock variable in a cache of the first core to MODIFIED based on a cache coherency protocol of the multicore system;
setting, by a second core of the one or more cores, a secondary variable based on a set of cores, including the second core, waiting for the spinlock, the setting of the secondary variable by the second core including changing a cache state of the secondary variable in a cache of the second core to MODIFIED based on the cache coherency protocol, wherein
the cache state of the secondary variable is set on a cache line that is separate from a cache line associated with the spinlock variable,
the second core comprises the spinlock variable as INVALID in the cache of the second core, and
the first core comprises the secondary variable as INVALID in the cache of the first core;
accessing, by the first core and not by the second core, a section of data;
releasing, by the first core, the spinlock after performing one or more operations on the section of the data; and
updating, by the first core, the INVALID secondary variable upon releasing the spinlock, the updating of the secondary variable including performing the updating such that a number of INVALID variables that are to be updated by each of the first core and the set of cores including the second core becomes equal.

2. The method as claimed in claim 1, wherein
the cache state of the spinlock variable being changed to the MODIFIED indicates that the cache line associated with the spinlock variable is only present in the cache of the first core,
the cache state of the secondary variable being changed to the MODIFIED indicates that the cache line associated with the secondary variable is only present in the cache of the second core,
the spinlock variable that is INVALID in the cache of the second core indicates that the cache line associated with the spinlock variable that is present in the cache of the second core is invalid, and
the secondary variable that is INVALID in the cache of the first core indicates that the cache line associated with the secondary variable that is present in the cache of the first core is invalid.

3. The method as claimed in claim 1, further comprising:
upon the releasing of the spinlock by the first core, updating, by the second core the INVALID spinlock variable in the cache of the second core in a case based on the second core waiting to acquire the spinlock.

4. The method as claimed in claim 1, further comprising:
upon releasing the spinlock, adding, by the first core, a delay time in resetting the secondary variable based on the second core waiting to acquire the spinlock,
wherein the delay time corresponds to a delay due to power saving optimization in at least one of the second core or the set of cores including the second core.

5. The method as claimed in claim 4 further comprising:
initiating a next iteration spinlock acquisition such that a probability of at least the first and second cores acquiring the spinlock is equal due to the delay time.

6. The method as claimed in claim 1, wherein the setting by the first core and the setting by the second core are performed in parallel.

7. A method for providing, to one or more cores in a multicore system, fair access to a spinlock, the method comprising:
setting, by a first core of the one or more cores, a spinlock variable in response to the spinlock being acquired by the first core, the setting of the spinlock variable by the first core including changing a cache state of the spinlock variable in a cache of the first core to MODIFIED based on a cache coherency protocol of the multicore system;
setting, by a second core of the one or more cores, a contention indication variable in response to the second core waiting for the spinlock, the second core comprises the spinlock variable as INVALID in a cache of the second core;
accessing, by the first core and not by the second core, a section of data;
releasing, by the first core, the spinlock after performing one or more operations on the section of the data; and
upon releasing the spinlock, cleaning and invalidating, by the first core, spinlock data from the cache of the first core in response to the contention indication variable being set.

8. The method as claimed in claim 7, wherein
the contention indication variable is set on a same cache line as the spinlock variable, or
the contention indication variable is not stored in a cache memory.

9. The method as claimed in claim 7, wherein the contention indication variable indicates that a contention is present for acquiring the spinlock.

10. The method as claimed in claim 7, wherein the cleaning and invalidating the spinlock data includes flushing the spinlock data from the cache of the first core and writing the spinlock variable to a main memory.

11. The method as claimed in claim 7, further comprising:
upon releasing the spinlock, adding, by the first core, a delay time in the cleaning and the invalidating the spinlock data based on the second core waiting for the spinlock,
wherein the delay time corresponds to a delay due to power saving optimization in the second core.

12. The method as claimed in claim 11, further comprising:
performing a next iteration spinlock acquisition such that a probability of at least the first and second cores acquiring the spinlock is equal due to the delay time.

13. The method as claimed in claim 7, wherein the setting by the first core and the setting by the second core are performed in parallel.

14. A multicore system, comprising:
a plurality of cores including a first core and a second core,
wherein the first core is configured to set a spinlock variable in response to the spinlock being acquired by the first core, wherein the setting of the spinlock variable by the first core includes changing a cache state of the spinlock variable in a cache of the first core to MODIFIED based on a cache coherency protocol of the multicore system,
wherein the second core is configured to set a secondary variable based on a set of cores including the second core waiting for the spinlock, wherein the setting of the secondary variable by the second core includes changing a cache state of the secondary variable in a cache of the second core to MODIFIED based on the cache coherency protocol,
wherein the cache state of the secondary variable is set on a cache line that is separate from a cache line associated with the spinlock variable,
wherein the second core comprises the spinlock variable as INVALID in the cache of the second core based on the set of cores including the second core waiting for the spinlock,
wherein the first core comprises the secondary variable as INVALID in the cache of the first core in response to the spinlock being acquired by the first core; and
wherein the first core is further configured to
access a section of data,
release the spinlock after performing one or more operations on the section of data, and
update, upon releasing the spinlock, the INVALID secondary variable, the updating of the secondary variable includes performing the update such that a number of INVALID variables that are to be updated by each of the first core and the set of cores including the second core becomes equal.
